(19) United States
(12) Patent Application Publication
(10) Pub. No.: US 2020/0205440 A1
(43) Pub. Date: Jul. 2, 2020

(54) METHOD FOR IMPROVING ACCUMULATION OF A POLYUNSATURATED FATTY ACID IN AN ANIMAL

(71) Applicant: Calysta, Inc., Menlo Park, CA (US)

(72) Inventors: Joshua A. Silverman, Los Altos Hills, CA (US); Sungwon Lee, Fremont, CA (US)

(21) Appl. No.: 16/634,114

(22) PCT Filed: Aug. 16, 2018
(86) PCT No.: PCT/US2018/000302

§ 371 Date: Jan. 24, 2020

Related U.S. Application Data
(60) Provisional application No. 62/589,408, filed on Nov. 21, 2017.
(60) Provisional application No. 62/546,311, filed on Aug. 16, 2017.

(51) Int. Cl. A23K 10/16; A23K 20/158; A23K 50/80; A23K 50/75; A23K 10/30

(52) U.S. Cl. CPC A23K 10/16; A23K 20/158; A23K 10/30; A23K 50/75; A23K 50/80

(57) ABSTRACT

The present disclosure provides methods for improving accumulation of one or more polyunsaturated fatty acids in an animal through the use of a boosted feed composition comprising polyunsaturated fatty acids and a bacterial biomass (e.g., methylotrophic, methanotrophic, or both), wherein the animal that is fed and consumes the boosted feed composition accumulates the one or more polyunsaturated fatty acids more efficiently than when fed a reference feed composition lacking the bacterial biomass.

### BACKGROUND

Polyunsaturated fatty acids are lipids having more than one carbon-carbon double bond in their hydrocarbon chain, which can be found in a variety of biological sources (such as nuts, fish, and leafy greens) or can be chemically synthesized. The presence of multiple double bonds makes the polyunsaturated fatty acid molecules less rigid than corresponding saturated fatty acid molecules (i.e., the latter being a fatty acid molecule having no double-bonds between carbons), or than an unsaturated fatty acid molecule with fewer double bonds. This flexibility, and the length and degree of saturation of the constituent fatty acid chains, can have profound effects in biological contexts, such as the response of a lipid membrane to changes in temperature and pH, or the formation of undesirable plaques in complex organ systems.

Polyunsaturated fatty acids (PFAs) are classified into three generic groups based on chemical structure: (1) methylene-interrupted polyenes, which have at least two cis double bonds that are separated from each other by a single methylene bridge (—CH₂— unit); (2) conjugated fatty acids, which have two or more conjugated double bonds (i.e., which means that the single and double bonds alternate in the molecule); and (3) other polyunsaturated fatty acids, which do not have the chemical structure of methylene-interrupted polyenes or conjugated fatty acids.

Methylene-interrupted polyenes include the “essential” omega-3 and omega-6 fatty acids, as well as omega-9 fatty acids. Essential fatty acids, or EFAs, are high-value chemicals that are required for healthy physiological function in humans and other animals, but must be obtained from external sources because they are not synthesized de novo in sufficient quantities. For example, omega-3 fatty acids such as docosahexaenoic acid (DHA) and eicosapentaenoic acid (EPA) are essential for the growth, development, and functional maintenance of the brain, skin, cardiovascular and reproductive systems. Commercially, DHA and EPA are incorporated into functional foods, infant nutrition, bulk nutrition and animal health products.

However, numerous technical challenges are associated with efficiently delivering PFAs to end consumers (e.g., farmed animals, humans). For example, obtaining PFAs from natural sources or via chemical synthesis typically requires harsh production environments, expensive starting materials, use of limited environmental resources (e.g., fishmeal), or production of detrimental byproducts. Moreover, PFAs in functional foods are in some cases poorly retained by the end consumer. By way of illustration, a recent study of Norwegian salmon farming practices indicated that PFA retention from fishmeal was 46% in whole fish and 26% in fillets (see, e.g., Ystretoyl et al., Aquaculture 448:365, 2015). Thus, there is a need for methods and compositions that increase the efficiency of polyunsaturated fatty acid delivery to end consumers, including animals. The present disclosure meets such needs, and further provides other related advantages.

### SUMMARY

In certain aspects, the present disclosure provides a method for improving accumulation of a polyunsaturated fatty acid in an animal, comprising feeding to an animal a boosted feed composition in an amount and for a time sufficient for the animal to consume and assimilate the feed, wherein the boosted feed composition comprises: (a) a modified reference feed composition comprising a reduced amount of one or more polyunsaturated fatty acids as compared to the unmodified reference feed composition; and (b) a methylotrophic bacterial biomass in an amount ranging from about 5% wt/wt to about 55% wt/wt of the total amount of the boosted feed composition; wherein the animal that has consumed the boosted feed composition accumulates about the same or an increased amount of the one or more polyunsaturated fatty acids as compared to a control animal that is fed and has consumed the unmodified reference feed composition.

In other aspects, the present disclosure provides a method for improving accumulation of polyunsaturated fatty acid in an animal, comprising feeding to an animal a boosted feed composition in an amount and for a time sufficient for the animal to consume and assimilate the feed, wherein the boosted feed composition comprises: (a) a modified reference feed composition comprising the same or about the same amount of one or more polyunsaturated fatty acids as compared to the unmodified reference feed composition; and (b) a methylotrophic bacterial biomass in an amount ranging from about 5% wt/wt to about 55% wt/wt of the total amount of the boosted feed composition; wherein the animal that has consumed the boosted feed composition accumulates an increased amount of the polyunsaturated fatty acid as compared to a control animal that is fed and has consumed the unmodified reference feed composition.

### BRIEF DESCRIPTION OF THE DRAWINGS

FIG. 1 shows the apparent digestibility (y-axis) in yellowtail amberjack of fat and protein from diets versus the percent (wt/wt) amount of methylotrophic bacterial biomass (referred to as “bacterial meal” or “BM”) contained in a modified reference feed composition (%BM; x-axis). The modified reference feed composition comprises a reduced amount of fish meal (reduced by about 10%, 25%, and 50%). The control feed was the unmodified reference feed composition (0% BM). The dashed lines indicate the best-fit for the data and the implied digestibility was calculated by linear exptrapolation of the best-fit lines to 100% BM.

FIG. 2 shows the percentage of omega-3 polyunsaturated fatty acid EPA (eicosapentaenoic acid) of the total fatty acids (FA) (y-axis; % wt/wt) present in dried fillet samples from yellowtail amberjack that were fed either the reference feed composition (0% BM) or one of three different boosted feed compositions (10%, 25% or 50% BM) (x-axis). Data points correspond to individual fish.

FIG. 3 shows the percentage of omega-3 polyunsaturated fatty acid DHA (docosahexaenoic acid) of the total fatty acids (FA) (y-axis; % wt/wt) present in dried samples from yellowtail amberjack that were fed either the reference feed composition (0% BM) or one of three different boosted feed compositions (10%, 25% or 50% BM) (x-axis). Data points correspond to individual fish fillet.

FIG. 4 shows the percentage (% wt/wt) of EPA of the total fatty acids (FA) present in dried saples of reference and boosted feed compositions fed to the fish from FIG. 2 (see, also, Example 2). Data points correspond to individual samples (n=2 for each feed).

FIG. 5 shows the percentage (% wt/wt) of DHA of the total fatty acids (FA) present in dried samples of reference and boosted feed compositions fed to the fish from FIG. 3 (see, also, Example 2). Data points correspond to individual samples (n=2 for each feed).

FIG. 6 shows the percentage of omega-3 polyunsaturated fatty acid EPA (eicosapentaenoic acid) of the total fatty acids (FA) (y-axis; % wt/wt) present in dried fillet samples from trout that were fed either the reference feed composition (0% BM) or one of three different boosted feed compositions (10%, 20% or 35% BM) (x-axis). Data points correspond to individual fish fillet.

FIG. 7 shows the percentage of omega-3 polyunsaturated fatty acid DHA (docosahexaenoic acid) of the total fatty acids (FA) (y-axis; % wt/wt) present in dried fillet samples from trout that were fed either the reference feed composition (0% BM) or one of three different boosted feed compositions (10%, 20% or 35% BM) (x-axis). Data points correspond to individual fish fillet.

FIG. 8 shows the percentage (% wt/wt) of EPA of the total fatty acids (FA) present in dried fillet samples of reference and boosted feed compositions fed to the trout from FIG. 6 (see, also, Example 3). Data points correspond to individual samples (n=2 for each feed).

FIG. 9 shows the percentage (% wt/wt) of DHA of the total fatty acids (FA) present in dried fillet samples of reference and boosted feed compositions fed to the trout from FIG. 7 (see, also, Example 3). Data points correspond to individual samples (n=2 for each feed).

### DETAILED DESCRIPTION

The present disclosure relates to compositions and methods for improving accumulation of polyunsaturated fatty acids (PFAs) in an animal, such as aquaculture animals (e.g., fin fish). In particular, there are provided boosted feed compositions that include the use of a modified reference feed composition comprising one or more polyunsaturated fatty acids (which may or may not have a reduced amount of the one or more polyunsaturated fatty acids as compared to the unmodified reference feed composition) in combination with or mixed with a methylotrophic bacterial biomass. The methylotrophic bacterial biomass comprises from about 5% wt/wt to about 55% wt/wt of the total amount of the boosted feed composition fed to an animal. Surprisingly, animals fed a boosted feed composition of this disclosure are capable of absorbing or accumulating an increased amount of PFAs as compared to animals fed a reference feed composition lacking the methylotrophic bacterial biomass component (i.e., an unmodified reference feed), even when the boosted feed composition contains a smaller total amount of PFAs as compared to the reference feed composition.

By way of background, mammals (including humans) can synthesize most of the fats needed through their normal diet, but some fats cannot be naturally synthesized in the body and are referred to as “essential fatty acids.” Several PFAs are essential fatty acids, including omega-3 and omega-6 fatty acids (e.g., a-linolenic acid and arachidonic acid). Certain non-mammal marine organisms, such as squid, krill, and fish, are natural sources of essential fatty acids, and products from these animals are consumed directly by humans or are used to supplement feed compositions for farmed animals, such as fish or shrimp (see, e.g., Sprague et al., Nature Sci. Rep. 6:21892 DOI: 10.1038/srep21892, 2016). Data from multiple sources has shown that the level of omega-3 oils in the diet of farmed animals is closely correlated with the omega-3 levels found in the farmed animals (Nuez-Ortín et al., PLoS One 11:8, 2016; Henriques et al., Br. J .Nutrition 112:964, 2014; Hardy and Lee, Bull. Fish. Res. Agen. 31:43, 2010; Bell et al., J. Nutrition 132:222, 2002).

However, current methods for obtaining PFAs for use in animal feeds are resource-inefficient. For example, the primary PFA sources used in fish aquaculture, including fish meal and fish oil, are not sustainable. See Sprague et al., supra. Another source of PFAs include some naturally occurring bacteria, which are known to produce long-chain (LC) omega-3 PFAs, but these bacteria generally inhabit deep, cold-water marine environments and culturing these bacteria under such growth conditions is difficult to replicate in a commercial setting. As the human population and accompanying demand for PFA-rich nutrient sources increases, improving the delivery efficiency of PFAs (e.g., accumulation by final animals) is an important aspect of sustainable and cost-effective food production. The current belief is that any ingredient removed from a feed must be replaced with a complementary feed ingredient that avoid an imbalance or deficiency of nutrients, and provide good digestability and availability to allow equal delivery of nutrients to the animals being fed. The instant disclosure provides improved feed compositions that are lower cost and environmentally sustainable, do not compromise the nutrition of the animals being fed, and increases or boosts the efficiency of PFA accumulation, such as omega-3 fatty acid eicosapentaenoic acid (EPA), in animals (e.g., aquaculture animals like fin fish) that consume such boosted feed compositions.

Prior to setting forth this disclosure in more detail, it may be helpful to an understanding thereof to provide definitions of certain terms to be used herein. Additional definitions are set forth throughout this disclosure.

In the present description, any concentration range, percentage range, ratio range, or integer range is to be understood to include the value of any integer within the recited range and, when appropriate, fractions thereof (such as one tenth and one hundredth of an integer), unless otherwise indicated. Also, any number range recited herein relating to any physical feature, such as polymer subunits, size or thickness, are to be understood to include any integer within the recited range, unless otherwise indicated. As used herein, the term “about” means ±20% of the indicated range, value, or structure, unless otherwise indicated. The term “consisting essentially of” limits the scope of a claim to the specified materials or steps, or to those that do not materially affect the basic and novel characteristics of the claimed invention. It should be understood that the terms “a” and “an” as used herein refer to “one or more” of the enumerated components. The use of the alternative (e.g., “or”) should be understood to mean either one, both, or any combination thereof of the alternatives. As used herein, the terms “include,” “have” and “comprise” are used synonymously, which terms and variants thereof are intended to be construed as non-limiting.

As used herein, “C₁ substrate” or “C₁ compound” refers to an organic compound or composition containing an organic compound lacking a carbon-carbon bond. Exemplary C₁ substrates include natural gas, unconventional natural gas, biogas, methane, methanol, formaldehyde, formic acid or a salt thereof, methylated amines (e.g., methylamine, dimethylamine, trimethylamine, etc.), methylated thiols, methyl halogens (e.g., bromomethane, chloromethane, iodomethane, dichloromethane, etc.), cyanide, or any combination thereof. In certain embodiments, a C₁ substrate comprises natural gas or methane.

As used herein, the term “methanotroph,” “methanotrophic bacterium,” or “methanotrophic bacteria” refers to bacteria capable of utilizing methane or any other methane-containing Cᵢ substrate (e.g., natural gas), as its primary or sole carbon and energy source. Methanotrophic bacteria may be “obligate methanotrophic bacteria,” which can only utilize methane as a carbon and energy source, or “facultative methanotrophic bacteria,” which are able to use substrates other than methane as their carbon and energy source, such as methanol. Representative obligate methanotrophs include species of Methylococcus, Methylosinus, Methylomonas, Methylomicrobium, Methylobacter, (e.g., Methylococcus capsulatus Bath, Methylosinus trichosporium OB3b, Methylomonas sp. 16a, Methylomonas methanica, Methylomonas albus, Methylomicrobium alcaliphilum, Methylobacter capsulatus, Methylomonas sp. AJ-3670, Methylomicrobium buryatense 5G, Methylosinus sporium), or the like. Facultative methanotrophs include, for example, some species of Methylocella, Methylocystis, and Methylocapsa (e.g., Methylocella silvestris, Methylocella palustris, Methylocella tundrae, Methylocystis daltona SB2, Methylocystis bryophila, and Methylocapsa aurea KYG), and Methylobacterium organophilum.

As used herein, the term “methylotroph,” “methylotrophic bacterium,” or “methylotrophic bacteria” refers to bacteria capable of utilizing reduced carbon compounds containing one or more carbon atoms but containing no carbon-carbon bonds (e.g., methanol) as its primary or sole carbon and energy source. Methylotrophic bacteria may be “obligate methylotrophic bacteria,” which can only utilize methanol or other carbon compounds containing no carbon-carbon bonds (e.g., methylamine) as a carbon and energy source, or “facultative methanotrophic bacteria,” which are able to use substrates other than methanol as their carbon and energy source, such multi-carbon substrates containing carbon-carbon bonds (e.g., acetate, pyruvate, succinate, malate, or ethanol). In particular embodiments, methylotrophic bacteria are capable of utilizing methane as their carbon and energy source and such methylotrophic bacteria are considered facultative methanotrophic bacteria.

As used herein, “bacterial biomass” refers to one or more of whole cells, lysed cells, cell membranes, cell cytoplasm, inclusion bodies, extracellular material (e.g., products secreted or excreted into the culture medium), or the like from a bacterial culture.

As used herein, “methylotrophic bacterial biomass” refers to one or more of whole cells, lysed cells, extracellular material, or the like obtained from a methylotrophic bacterial culture, a methanotrophic bacterial culture, or both. For example, the material harvested from cultured methylotrophic bacteria, from cultured methanotrophic bacteria, or from both is considered the “methylotrophic bacterial biomass,” which can include whole cells, lysed cells, cell membranes, cell cytoplasm, inclusion bodies, products secreted or excreted into the culture medium, or any combination thereof Methanotrophic and methylotrophic bacteria useful for producing a biomass include naturally occurring strains (e.g., “wild-type”), or variants thereof that have one or more desired characteristics, capacities, or functionalities, such as high growth variants. A bacterial biomass from cultured methanotrophic bacteria is referred to as a “methanotrophic bacterial biomass.”

The term “polyunsaturated fatty acid” or “PFA” (also known as “PUFA”), as used herein, refers to a carboxylic acid molecule with a long aliphatic carbon chain (i.e., fatty acid backbone) that has at least two carbon-carbon double-bonds in its backbone. PFAs can be further defined by the length of the carbon backbone: “short-chain PFAs” or “SC-PFAs” have fewer than 20 carbon molecules in the fatty acid backbone; “long-chain PFM” or “LC-PFAs” have from 20 to 27 carbon molecules in the fatty acid backbone; and “very long-chain PFAs” (also called “VLC-PFAs” herein) have 28 carbon molecules or more in the fatty acid backbone. As used herein, PFAs are named according to the X:Y(n-Z) convention, wherein X is the number of carbon atoms in the PFA backbone, Y is the number of carbon-carbon double bonds (C═C bonds), and Z is the position of the first carbon of the first double bond (counting inward from the carboxy end, n). The carbon at the carboxy end of a fatty acid chain (n) is also referred to as the omega-carbon (or co-carbon); therefore, the PFAs may also he referred to as omega-Z PFAs.

Exemplary SC-PFAs include hexadecatrienoic acid (“HTA”; 16:3(n-3)), α-linolenic acid (“ALA”; 18:3 (n-3), stearidonic acid (“SDA”; 18:4 (n-3)), linoleic acid (“LLA”; 18:2(n-6)), and γ-linoleic acid (“GLA”; 18:3(n-6)). HTA, ALA, and SDA are omega-3 (ω-3) fatty acids, and LLA and GLA are omega-6 (ω-6) fatty acids.

Exemplary LC-PFAs include eicosatrienoic acid (“ETE”; 20:3(n-3)), eicosatetraenoic acid (“ETA”; 20:4(n-3)), eicosapentaenoic acid (“EPA”; 20:5(n-3)), heneicosapentaenoic acid (HPA; 21:5(n-3)), docosapentaenoic acid (DPA; 22:5(n-3)), docosahexaenoic acid (DHA; 22:6(n-3)), tetracosapentaenoic acid (TPA; 24:5(n-3)), tetrahexaenoic acid (THA; 24:6(n-3)), eicosadienoic acid (20:6(n-6)), dihomo-gamma-linolenic acid (DGLA; 20:3(n-6), arachidonic acid (AA; 20:4(n-6), docosadienoic acid (22:2(n-6)), adrenic acid (22:4)(n-6)), adrenic acid (22:4(n-6), docosapentaenoic acid (22:5(n-6)), tetracosatetraenoic acid (24:4 (n-6)), and tetracosapentaenoic acid (24:5(n-6)). LC-PFAs with an (n-3) designation are also referred to as omega-3 fatty acids, while those with an (n-6) designation are also referred to as omega-6 fatty acids.

As used herein, a “feed composition” contains a range of ingredients nutritionally formulated to provide the animal being fed all the correct nutrients in the form of protein, fat, carbohydrate, vitamins and minerals. The source of protein and fat may be from, for example, a marine animal (e.g., fish meal, fish oil, krill meal), a land animal (e.g., poultry meal, poultry oil, meat meal, bone meal, feather meal), a plant (e.g., soy protein concentrate, soy meal, corn gluten meal, wheat gluten meal, wheat flour, algal meal, pulses/grain legumes, flax (linseed) oil, canola oil). Feed compositions for aquaculture will include a polyunsaturated fatty acid-containing component, which may be contained in, for example, fish meal or fish oil. A fccd composition of this disclosure may be optionally supplemented with additional components, such as an organic acid, a preservative (e.g., mold inhibitor), toxin inhibitor (e.g., mycotoxin binder such as aluminosilicates clays and zeolites), an antioxidant, a probiotic, a colorant, an odorant, an attractant, a palatant, an essential amino acid, diatomaceous earth, or any combination thereof. The source of each of the components of a feed composition may differ, but the ingredients found within each component are not necessarily mutually exclusive. For example, a plant component from a soy plant and a protein component from a fish can both contain protein and oil, but the specific proteins or oils will be different for each source.

A “reference feed composition” or “unmodified reference feed composition,” as used herein, refers to a feed composition to be fed to a control animal and comprises ingredients generally used to feed that particular animal. For example, a reference feed composition for yellowtail can include fish meal, fish oil, Schizochytrium meal, soy protein concentrate, vitamin premix, mineral premix, lysine, and taurine.

A “modified reference feed composition,” as used herein, refers to a feed composition in which one or more components, ingredients, or portions thereof are decreased or increased in amount relative to a reference feed composition, or are replaced or substituted with one or more other components or ingredient as compared to the reference feed composition, such as a reduced amount or absence of a protein component (e.g., fish or Schizochytrium meal), a plant component (e.g., soy), an oil (e.g., fish oil), a vitamin, a mineral, or any combination thereof. In certain embodiments, the modification comprises one or more PFAs in an amount that is reduced as compared to the reference feed composition. For example, a modified reference feed composition comprises a reduced amount of a PFA-containing ingredient (e.g., fish meal) as compared to the reference feed composition. The removed or decreased ingredient may be replaced or substituted by another ingredient or component, such as, for example, a methylotrophic bacterial biomass. Replacement or substitution of ingredients or components can be in whole or in part, meaning that, for example, the replacement or substitution can be in a 1:1 ratio of replaced ingredient to substitute ingredient, or can be in a different ratio. Thus, in certain embodiments, the amount of the substitute ingredient is more than or less than the amount of the ingredient being replaced. For example, in certain embodiments, a modified reference feed composition comprises a decreased amount of fishmeal that is replaced in whole or in part by a methylotrophic bacterial biomass. A modified reference feed composition according to the present disclosure may comprise one or more components that are present in a greater or lesser amount than found in the (unmodified) reference feed composition.

As used herein, a “boosted feed composition” refers to a modified or unmodified reference feed composition used in combination with or mixed a methylotrophic bacterial biomass. In certain embodiments, a methylotrophic bacterial biomass is a substitute for or used in place of a polyunsaturated fatty acid component or a portion thereof from a reference feed composition. In other words, a methylotrophic bacterial biomass is combined with a modified reference feed composition, wherein the modified reference feed composition comprises a reduced amount of a polyunsaturated fatty acid component, such as fish meal or fish oil. In other embodiments, a methylotrophic bacterial biomass is used or combined with a modified reference feed composition, wherein the modified reference feed composition comprises an altered amount of one or more ingredients, such as a aprotein component (e.g., fish or Schizochytrium meal), a plant component (e.g., soy), an oil (e.g., fish oil), a vitamin, a mineral, or any combination thereof. That is, a methylotrophic bacterial biomass can be used or combined with a modified reference feed composition having a greater or lesser amount of an ingredient of the reference feed composition. In further embodiments, a methylotrophic bacterial biomass is used or combined with an unmodified reference feed composition.

As used herein, the term “modified” or “recombinant” or “non-natural” refers to an organism, microorganism, cell, nucleic acid molecule, or vector that includes at least one genetic alternation or has been modified by the introduction of a heterologous polynucleotide, or refers to a cell that has been altered such that the expression of an endogenous nucleic acid molecule or gene can be controlled, where such alterations or modifications are introduced by genetic engineering. Genetic alterations include, for example, modifications introducing expressible polynucleotides or nucleic acid molecules encoding proteins or enzymes, other polynucleotide or nucleic acid molecule additions, nucleic acid deletions, nucleic acid substitutions, or other functional disruption of the cell's genetic material. Such modifications include, for example, coding regions and functional fragments thereof for heterologous or homologous polypeptides for the referenced species. Additional modifications include, for example, non-coding regulatory regions in which the modifications alter expression of a gene or operon. Genetic modifications to polynucleotides or nucleic acid molecules encoding enzymes, or functional fragments thereof, can confer a biochemical reaction capability or a metabolic pathway capability to the recombinant cell that is altered from its naturally occurring state. For example, a methanotrophic or methylotrophic bacteria or both may be engineered to synthesize non-endogenous PFAs are described in U.S. provisional patent application No. 62/441,051, the genetically engineered methanotrophic or methylotrophic bacteria of which are incorporated herein in their entirety.

As used herein, a “farm animal” refers to any domestic species of cattle, sheep, swine, goats, llamas, or horses that are normally kept and raised on farms, and used or intended for use as food or fiber, or for improving animal nutrition, breeding, management, or production efficiency, or for improving the quality of food or fiber. Other exemplary farm animals include rabbits, mink, and chinchilla, when they are used for purposes of meat or fur, and animals such as horses and llamas when used as work and pack animals. In certain embodiments, a farm animal comprises cows, pigs, sheep, chickens, turkeys, or horses.

As used herein, a “farmed animal” refers to the cultivation of animals in natural or controlled environments. Aquaculture is an example of farmed aquatic animals, such as fish (also known as fin fish) or shellfish. Exemplary aquaculture animals include fish (e.g., Atlantic salmon, trout, yellowtail, red snapper, barramundi, kampachi, catfish, and tilapia) and shellfish (e.g., shelled mollusk such as scallops, clams, oysters and mussels; crustacean such as shrimp or crayfish). In certain embodiments, the farmed animal is a fish or shrimp. In certain embodiments, the fish is a salmonid (e.g., a salmon or trout), a mackerel, or a herring.

A “fish” or “fin fish” refers to any cold-blooded, strictly aquatic, water-breathing craniate vertebrate with fins, including cyclostomes, elasmobranchs and higher-gilled aquatic vertebrates, with a bony (Osteichthyes) or cartilaginous (Chondrichthyes) skeleton (sometimes referred to as a “true fish”) or any part thereof, as distinguished from and not including flat fish (which are of the order pleuronectiformes, the adults of which have both eyes on one side and usually swim with the other side down), shellfish or other aquatic animals.

As used herein, a “domesticated animal” refers to a vertebrate animal that has been tamed and made fit for a human environment. Exemplary domesticated animals include dogs, cats, any equine or bovine animal, goat, sheep, swine, poultry, or the like.

### Boosted Feed Compositions

In certain aspects, the present disclosure provides methods for improving accumulation of polyunsaturated fatty acids in an animal, wherein the methods comprise feeding an animal a boosted feed composition in an amount and for a time sufficient for the animal to consume and assimilate the feed, wherein the boosted feed composition comprises: (a) a modified reference feed composition comprising a reduced amount of one or more polyunsaturated fatty acids as compared to the unmodified reference feed composition; and (b) a bacterial biomass (e.g., methanotrophic, methylotrophic, or both) in an amount ranging from about 5% wt/wt to about 55% wt/wt of the total amount of the boosted feed composition; wherein the animal that has consumed the boosted feed composition accumulates about the same or an increased amount of one or more polyunsaturated fatty acid as compared to a control animal that is fed and has consumed the unmodified reference feed composition.

In certain embodiments, an animal accumulates about the same amount of one or more polyunsaturated fatty acids from the boosted feed composition as compared to the control animal that was fed and consumed the unmodified reference feed composition. In some embodiments, an animal accumulates an increased amount of one or more polyunsaturated fatty acids from the boosted feed composition as compared to the control animal that was fed and consumed the unmodified reference feed composition.

In other aspects, the present disclosure provides methods for improving accumulation of polyunsaturated fatty acid in an animal, comprising feeding to an animal a boosted feed composition in an amount and for a time sufficient for the animal to consume and assimilate the feed, wherein the boosted feed composition comprises: (a) a modified reference feed composition comprising the same or about the same amount of one or more polyunsaturated fatty acids as compared to the unmodified reference feed composition; and (b) a bacterial biomass (e.g., methanotrophic, methylotrophic, or both) in an amount ranging from about 5% wt/wt to about 55% wt/wt of the total amount of the boosted feed composition; wherein the animal that has consumed the boosted feed composition accumulates an increased amount of the polyunsaturated fatty acid as compared to a control animal that is fed and has consumed the unmodified reference feed composition.

In further embodiments, the modified reference feed composition and the bacterial biomass of the boosted feed composition are fed to the animal separately, or the boosted feed composition comprises the modified reference feed composition and the bacterial biomass formulated together as a mixture, wherein the mixture is fed to the animal (i.e., wherein the modified reference feed composition and the bacterial biomass are fed to the animal together). In any of these embodiments, the modified reference feed composition, the methylotrophic bacterial biomass or the combination thereof is formulated as a pellet.

In certain embodiments, a bacterial biomass used in a boosted feed composition of this disclosure comprises a methylotrophic bacterial biomass comprised of methanotrophic bacteria, methylotrophic bacteria, or both of this disclosure, together with the media of the culture in which the methylotrophic bacteria or methanotrophic bacteria or both were grown. In further embodiments, a bacterial biomass comprises a methylotrophic bacterial biomass comprised of methanotrophic bacteria, methylotrophic bacteria, or both (whole or lysed or both) of this disclosure, recovered from a culture grown on a C₁ substrate (e.g., methane, methanol). In still further embodiments, a bacterial biomass comprises a methylotrophic bacterial biomass comprised of spent media supernatant from a culture of methanotrophic bacteria, methylotrophic bacteria, or both, recovered from a culture grown on a C₁ substrate (e.g., methane, methanol).

In any of the aforementioned embodiments, a bacterial biomass comprises a methylotrophic bacterial biomass. In certain embodiments, a methylotrophic bacterial biomass comprises primarily methanotrophic bacteria, such as obligate methanotrophic bacteria or high-growth variants thereof (e.g., Methylococcus capsulatus Bath, Methylosinus trichosporium OB3b, Methylomonas sp. 16a) or facultative methanotrophic bacteria (e.g., a Methylocystis species, a Methylocapsa species). In further embodiments, a methylotrophic bacterial biomass consists essentially of methanotrophic bacteria grown as an isolated culture, or comprises primarily methanotrophic bacteria grown with a heterologous organism that may, for example, aid with growth (such as Alcaligenes acidovorans, Bacillus firmus or both and optionally in combination with Bacillus brevis), or one or more of a facultative methanotrophic and facultative methylotrophic bacteria may be combined as a mixed culture. In certain embodiments, a bacterial biomass comprises a methanotrophic bacterial biomass. In particular embodiments, methanotrophic bacteria for use in compositions and methods of this disclosure include Methylococcus capsulatus Bath, Methylosinus trichosporium OB3b, Methylomonas sp. 16a, Methylomonas methanica, Methylomonas albus, Methylomicrobium alcaliphilum, Methylobacter capsulatus, Methylomonas sp. AJ-3670, Methylomicrobium buryatense 5G, Methylosinus sporium, Methylocystis parvus, Methylocapsa palsarum, Methylobacterium organophilum, Methylocella silvestris, Methylocella palustris, Methylocella tundrae, Methylocystis daltona SB2, Methylocystis bryophila, Methylocapsa aurea KYG, Methylacidiphilum fumariolicum, Methyloacida kamchatkensis, Methylacidiphilum infernorum, or high-growth variants thereof.

In still further embodiments, a bacterial biomass comprises a methylotrophic bacterial biomass comprised primarily of methylotrophic bacteria, such as obligate methylotrophic bacteria (e.g., Methylophilus methylotrophus) or facultative methylotrophic bacteria (e.g., Methylobacterium extorquens). In particular embodiments, bacterial methylotrophs for use in the compositions and methods of this disclosure include Methylobacterium extorquens, Methylobacterium radiotolerans, Methylobacterium populi, Methylobacterium chloromethanicum, Methylobacterium nodulans, Methylophilus methylotrophus, or high-growth variants thereof.

Boosted feed compositions of this disclosure are tailored to suit the particular animal species, size, biology and environmental conditions, or other conditions (e.g., whether an animal is farmed, domesticated or a farm animal). For example, a boosted feed composition of this disclosure for a fish comprises a protein component (e.g., fish meal, soy protein), an oil (e.g., fish oil), vitamins (e.g., vitamin premix) and minerals (e.g., mineral premix). Fish meal has a high content of protein that is of high nutritional quality (e.g., high-quality fish meal normally contains between 60% and 72% crude protein by weight), which is used to supplement other proteins, such as vegetable proteins, in the diets of farmed animals. Fish meal contains PFAs, though not as much as fish oil, because most fish meal is prepared from whole fish by cooking, pressing, drying and grinding the fish, so only water and some oil are extracted from the fish. By way of background, about 90% of world fish meal production is from wild-caught oily fish species, such as mackerel, pilchard, capelin and menhaden (generally, fish containing a high percentage of bones and oil, and not suitable for direct human consumption); less than 10% is from white fish offal such as from cod and haddock; and only 1% is produced from other sources such as shellfish and whales (see www.fao.org/docrep/003/x6899e/X6899E11.htm, from the Fisheries and Aquaculture Department of the United Nations). In certain embodiments, a boosted feed composition for fish may contain from about 30% to about 45% total protein by weight, and diets for shrimp may contain from about 25% to about 45% total protein. The percentages of inclusion rate of fish meal in diets for carp and tilapia may be, for example, from about 5% to about 10%, and up to about 40% to about 55% for trout, salmon, and some marine fishes. A typical inclusion rate of fish meal in terrestrial livestock diets is generally lower than for fish, such as about 5% or less on a dry matter basis.

In some embodiments, a boosted, modified or unmodified reference feed composition of the present disclosure comprises a methylotrophic bacterial biomass, a polyunsaturated fatty acid-containing component (e.g., fish oil, fish meal), a protein component, a plant component, an organic acid, an oil, a vitamin, and a mineral, and optionally a viscosity increasing agent, a binding agent, an anti-caking agent, or any combination thereof.

In certain embodiments, a boosted feed composition according to the present disclosure comprises a methylotrophic bacterial biomass and one or more polyunsaturated fatty acids (PFAs), such as omega-3 fatty acids. In some embodiments, a methylotrophic bacterial biomass is present in a boosted feed composition in an amount ranging from about 1% wt/wt to about 55% wt/wt (i.e., percent dry weight of the total amount of the boosted feed composition). In further embodiments, a methylotrophic bacterial biomass is present in a boosted feed composition in an amount ranging from about 5% wt/wt to about 55% wt/wt of the total amount of the boosted feed composition, or is present in an amount of about 10%, about 15%, about 20%, about 25%, about 30%, about 35%, about 40%, about 45%, about 50%, or about 55% wt/wt of the total amount of the boosted feed composition. In any of the aforementioned embodiments, such a boosted feed composition comprises an aquaculture boosted feed composition for fish or shellfish.

Boosted feed compositions of the present disclosure may comprise one or more PFAs in a polyunsaturated fatty acid-containing component, such as a plant, animal, or bacterial source of the one or more PFA. In certain embodiments, a boosted feed composition comprises one or more polyunsaturated fatty acid-containing component in an amount ranging from about 1% wt/wt to about 95% wt/wt. In certain embodiments, the polyunsaturated fatty acid-containing component comprises fish oil, fish meal, squid oil, squid meal, squid liver powder, algal oil, shrimp head meal, krill oil, krill meal, or any combination thereof Polyunsaturated fatty acids comprised in feed compositions according to the present disclosure may include one or more omega-3 fatty acid. In certain embodiments, the one or more omega-3 fatty acid comprises docosahexanoic acid (DHA). In certain embodiments, the one or more omega-3 fatty acid comprises eicosapentaenoic acid (EPA). In certain embodiments, the one or more omega-3 fatty acid comprises DHA and EPA. Other PFAs that may be present in feed compositions according to the present disclosure include hexadecatrienoic acid (HTA), α-linolenic acid (ALA), stearidonic acid (SDA), linoleic acid (LLA), γ-linoleic acid (GLA), eicosatrienoic acid (ETE), eicosatetraenoic acid (ETA), eicosapentaenoic acid (EPA), heneicosapentaenoic acid (HPA), docosapentaenoic acid (DPA), docosahexaenoic acid (DIIA), tetiacusapentaenoic acid (TPA), tetrahexaenoic acid (THA), eicosadienoic acid dihomo-gamma-linolenic acid (DGLA), arachidonic acid (AA), docosadienoic acid, adrenic acid, docosapentaenoic acid, tetracosatetraenoic acid, tetracosapentaenoic acid, and hentriacontanonaene, either individually or in any combination. For example, fish oil is a major natural source of EPA and DHA.

In some embodiments, a PFA component (e.g., fish oil, fish meal, squid oil, squid meal, squid liver powder, algal oil, shrimp head meal, krill oil, hill meal) is present in a boosted feed composition in an amount ranging from about 1 wt % to about 80 wt %, about 1 wt % to about 70 wt %, about 5 wt % to about 95 wt %, about 5 wt % to about 75 wt %, about 10 wt % to about 85 wt %, about 10 wt % to about 75 wt %, about 10 wt % to about 70 wt %, about 10 wt % to about 65 wt %, about 10 wt % to about 60 wt %, about 15 wt % to about 60 wt %, or about 15 wt % to about 50 wt % of the total amount of the boosted feed composition, or is present in an amount of about 10%, about 15%, about 20%, about 25%, about 30%, about 35%, about 40%, about 45%, about 50%, about 55% wt/wt, about 60%, about 65% wt/wt, about 70%, about 75% wt/wt, about 80%, about 85% wt/wt, about 90%, or about 95% wt/wt of the total amount of the boosted feed composition. In certain embodiments, a PFA component is present in a boosted feed composition in an amount ranging from about 1 wt % to about 70 wt % or about 5 wt % to about 75 wt %, such as fish oil, fish meal, or both.

In particular embodiments, a boosted feed composition comprises a methylotrophic bacterial biomass in an amount ranging from about 5 wt % to about 55 wt % of the total amount of the boosted or reference feed composition, and a fish meal in an amount ranging from about 10 wt % to about 70 wt % of the total amount of the boosted feed composition. In further embodiments, a boosted feed composition comprises a methylotrophic bacterial biomass in an amount ranging from about 10 wt % to about 50 wt % of the total amount of the boosted feed composition, and a fish meal in an amount ranging from about 20 wt % to about 50 wt % of the total amount of the boosted feed composition. In still further embodiments, a boosted feed composition comprises the methylotrophic bacterial biomass in an amount ranging from about 25 wt % to about 50 wt % of the total amount of the boosted feed composition, and fish meal in an amount ranging from about 20 wt % to about 40 wt % of the total amount of the boosted feed composition.

In any of the aforementioned embodiments, a polyunsaturated fatty acid-containing component may be from a genetically modified plant (e.g., rapeseed), a genetically modified yeast, or a genetically modified bacteria (e.g., methylotroph, methanotroph).

As used herein, the ability of an animal to “accumulate” one or more PFA (e.g., from a dietary source) refers to its ability to take up (i.e., to absorb) or retain (i.e., to assimilate) one or more PFA from an exogenous source. By way of example, PFA accumulation is improved when the animal is able to take up or retain a greater proportion of PFA from an exogenous source. Without wishing to be bound by theory, it is believed that the inclusion of a methylotrophic bacterial biomass in a boosted feed composition comprising one or more PFA improves accumulation of the one or more PFA (and, optionally, other fatty acids) by the animal. However, bacterial biomass generally have undetectable levels of PFAs as compared to standard feed supplements, such as algal extracts or fish meal (which contains residual, but a significant amount of PFA-containing fish oil) (Yoshida et al., Mar. Drugs 14:94, 2016; Fang et al., FEMS Microbiol. Lett. 198:67, 2000; Guckert et al., J. Genetic Microbiol. 137:2631, 1991). Therefore, it was expected that a boosted feed composition in which standard protein sources are replaced by a methlyotrophic bacterial biomass would result in lower levels of PFA accumulation in animals fed such boosted feed compositions. Instead, and quite surprisingly, the examples of the present disclosure demonstrate that inclusion of methylotrophic bacterial biomass in a modified or unmodified PFA-containing reference feed composition results in improved accumulation of the PFA by the animal, even when the boosted feed composition contains a reduced amount of PFAs as compared to a reference feed composition.

PFA accumulation can be determined by analyzing the amount of PFA present in a tissue sample from the animal (e.g., edible portion, flesh, organ, scale, fin), or in a waste sample from the animal, which, in view of the the PFA content of the feed composition ingested by the animal, can indicate the degree of the accumulation. PFA accumulation can be analyzed using known techniques such as, for example, chemical titration, thermometric titration, enzymatic methods, mass spectrometry, and gas-liquid chromatogiaply methods.

In certain embodiments, feed compositions (boosted or reference) of the present disclosure comprise a plant component. Plant components are sometimes used as primary or a supplemental source of protein or other nutrients found in animal feeds (see, e.g., Ystretoyl, supra). In some embodiments, a boosted or reference feed composition according to the present disclosure comprises a plant component in an amount ranging from about 1% wt/wt to about 50% wt/wt, about 1% wt/wt to about 40% wt/wt, or about 5% wt/wt to about 35% wt/wt of the total amount of the boosted or reference feed composition. In particular embodiments, a plant component comprises soy (e.g., soy protein concentrate), pea (e.g., pea protein), dried distillers grains with solubles (DDGS), sunflower (e.g., sunflower expeller), rapeseed, wheat (e.g., wheat gluten, wheat flour), fava beans, maize (e.g., maize gluten), rice (e.g., rice bran de-olied), horse beans, or any combination thereof.

In certain embodiments, feed compositions (boosted or reference) of the present disclosure comprise a protein component. Exemplary protein components include those sources containing: (a) a high amount of protein, such as soybean meal, fish meal, meat and bone meal, corn gluten meal; (b) a medium amount of protein, such as rape meal, sunflower meal, palm/copra, peas and beans, corn gluten feed; (c) a lower amount of protein, such as milo (sorghum), pulses/grain legumes (dried peas, beans, lentils, chickpeas), groundnut oil meal, coconut oil meal, squid meal, poultry meal, feather meal, lupin, wheat gluten, peanut, canola, cottonseed. In some embodiments, a feed compositions (boosted or reference) of the present disclosure comprises a protein component in an amount ranging from about 1 wt % to about 70 wt %, about 5 wt % to about 60 wt %, about 10 wt % to about 55 wt %, or about 15 wt % to about 50 wt % of the total amount of the boosted or reference feed composition, such as a plant protein, a fish protein, an algal protein, and a bacterial protein. Representative plant protein comprises one or more of soy protein, pea protein, chickpea protein, bean protein, rice protein (e.g., rice bran), chia protein, hempseed protein, rapeseed protein, wheat protein, and quinoa protein. Representative fish protein comprises or is from fish meal, and representative algal protein comprises or is from algal meal, such as Schizochytrium meal.

In further embodiments, feed compositions (boosted or reference) of the present disclosure comprise an oil (i.e., from plants, algae or animals), which are sometimes used as a fatty acid source in a reference (unmodified or modified) or boosted feed compositions (see, e.g., Sprague et al., supra). In certain embodiments, feed compositions according to the present disclosure comprise a fish oil or plant oil in an amount ranging from about 5% wt/wt to about 35% wt/wt, about 10% wt/wt to about 45% wt/wt, or about 15% wt/wt to about 55% wt/wt of the total amount of the boosted or reference feed composition. Exemplary plant oils for use in the presently disclosed feed compositions include PFA, soy lecithin, cholesterol, rapeseed oil, linseed (flax seed) oil, borage seed oil, camelina oil, walnut, clary sage seed oil, algal oil, flaxseed oil, Plukenetia oil (e.g., Sacha inchi oil), Echium oil, hemp oil, or any combination thereof.

Algae and algae-derived products are sometimes used as primary sources or supplements of amino acids and lipids in animal feeds, and may aid in nutrient digestibility in farmed fish (see, e.g., Norambuena et al., PLoS One 10:e0124042, 2015). Exemplary algae sources include green algae, red algae, brown alge, and diatoms. In certain embodiments, feed compositions according to the present disclosure comprise algal meal in an amount ranging from about 0.5% wt/wt to about 10% wt/wt, about 1% wt/wt to about 7.5% wt/wt, or about 1.5% wt/wt to about 5% wt/wt of the total amount of the boosted or reference feed composition.

Vitamin supplements are sometimes included in animal feeds. In certain embodiments, feed compositions according to the present disclosure comprise one or more vitamins in an amount ranging from about 0.01% wt/wt to about 5% wt/wt, about 0.05% wt/wt to about 5% wt/wt, about 0.10% wt/wt to about 5% wt/wt, about 0.15% wt/wt to about 5% wt/wt, about 0.20% wt/wt to about 5% wt/wt, about 0.25% wt/wt to about 5% wt/wt, about 0.5% wt/wt to about 5% wt/wt, about 1% wt/wt to about 3% wt/wt, about 1% wt/wt to about 2% wt/wt, about 0.01% wt/wt to about 3% wt/wt, about 0.05% wt/wt to about 3% wt/wt, about 0.10% wt/wt to about 3% wt/wt, about 0.15% wt/wt to about 3% wt/wt, about 0.20% wt/wt to about 3% wt/wt, about 0.25% wt/wt to about 3% wt/wt, about 0.01% wt/wt to about 2% wt/wt, about 0.05% wt/wt to about 2% wt/wt, about 0.10% wt/wt to about 2% wt/wt, about 0.15% wt/wt to about 2% wt/wt, about 0.20% wt/wt to about 2% wt/wt, about 0.25% wt/wt to about 2% wt/wt, about 0.01% wt/wt to about 1% wt/wt, about 0.05% wt/wt to about 1% wt/wt, about 0.10% wt/wt to about 1% wt/wt, about 0.15% wt/wt to about 1% wt/wt, about 0.20% wt/wt to about 1% wt/wt, or about 0.25% wt/wt to about 1% wt/wt, of the total amount of the boosted or reference feed composition. Vitamins and dosages thereof appropriate to the animal receiving the feed (e.g., fish, poultry, dogs, cats) are known to those having ordinary skill in the art, and may include, for example, vitamin A, vitamin B-complex, vitamin C, vitamin D, vitamin E, vitamin K, riboflavin, folic acid, niacin, pyridoxine, inositol, biotin, pantothenic acid, butylated hydroxytoluene (BHT), thiamine, choline, or any combination thereof In particular embodiments, a boosted feed composition or a reference (unmodified or modified) feed composition comprises vitamin C or a vitamin premix.

In certain embodiments, feed compositions according to the present disclosure comprise one or more mineral in an amount ranging from about 0.01% wt/wt to about 5% wt/wt, about 0.05% wt/wt to about 4% wt/wt, or about 0.10% wt/wt to about 3% wt/wt of the total amount of the boosted or reference feed composition. Non-limiting examples of minerals that may be included in the feed compositions include di-calcium phosphate, phosphate (source can be from animal protein), phosphorous, calcium, iron, magnesium, cobalt, copper (e.g., copper sulfate), manganese, selenium (source can be from fish meal), zinc, chromium, iodine, or any form or combination thereof. In certain embodiments, a feed composition of this disclosure comprises a mineral premix.

Amino acids are used by organisms to build proteins, and the addition of essential amino acids is sometimes used to supplement feed compositions. In certain embodiments, a boosted or reference feed composition according to the present disclosure comprises an essential amino acid supplement in an amount ranging from about 0.001 wt % to about 1.5 wt %, about 0.005 wt % to about 1 wt %, or about 0.010 wt % to about 0.5 wt % of the total amount of the boosted or reference feed composition. In certain embodiments, an essential amino acid supplement comprises phenylalanine, valine, threonine, tryptophan, methionine, leucine, isoleucine, lysine, histidine, arginine, or any combination thereof In certain embodiments, an amino acid supplement comprises one or more of lysine, methionine, and tryptophan. In particular embodiments, an amino acid supplement comprises combinations of essential amino acids, such as phenylalanine plus tyrosine, methionine plus cysteine (source of lysine, methionine plus cysteine, and threonine can be from fish meal, soybean, cottonseed meal, canola, peanut, brewer's grains, or corn gluten).

In certain embodiments, boosted or reference feed compositions further comprise “organic acids,” which refers to C₁-C₇ compounds that are widely distributed in nature as normal constituents of plants or animal tissues, or are formed through microbial fermentation of carbohydrates (mainly in the large intestine). In certain embodiments, organic acids comprise sodium, potassium, or calcium salts. For example, taurine (also known as 2-aminoethanesulfonic acid) is an organic compound that is involved in many biological processes, including the formation of bile acid, osmoregulation, antioxidant activity, cell membrane stabilization, and modulation of calcium signaling. Other exemplary organic acids and salts thereof, include propionic acid, acetic acid, benzoic acid, citric acid, formic acid, fumaric acid, malic acid, tartric acid, and taurine. In some embodiments, an organic acid (such as propionic acid, acetic acid, benzoic acid, citric acid, formic acid, fumaric acid, malic acid, tartric acid) may be included as a preservative (e.g., mold inhibitor). In certain embodiments, feed compositions according to the present disclosure comprise an organic acid, such as taurine, in an amount ranging from about 0.05% wt/wt to about 2.5% wt/wt, about 0.10% wt/wt to about 2% wt/wt, or about 0.50% wt/wt to about 1.5% wt/wt of the total amount of the boosted or reference feed composition.

In certain embodiments, a feed composition according to the present disclosure comprises a supplemental component, such as, for example, an antioxidant, a probiotic, a colorant, an odorant, an attractant, a palatant, a marker, or any combination thereof. Exemplary antioxidants include astaxanthin, ethoxyquin, butylated hydroxytoluene, butylated hydroxyanisole, propyl gallate, citric acid, and vitamin C. In another example, yttrium oxide (Yb₂O₃) can be added as an inert marker in some fish feeds to assess digestibility (see, e.g., Hatlen et al., Aquaculture 435:301, 2015). In certain embodiments, a feed composition comprises an antioxidant, a probiotic, colorant, odorant, attractant, and/or palatant in an amount ranging from about 0.01 wt % to about 1 wt % of the total amount of the boosted or reference feed composition.

In certain embodiments, feed compositions according to the present disclosure comprise a viscosity-increasing agent in an amount ranging from about 1% wt/wt to about 5% wt/wt of the total amount of the boosted or reference feed composition. Exemplary viscosity-increasing agents include alginate, bentonite, tapioca, or any combination thereof.

Binding agents and anti-caking agents are often used in feed compositions comprising dry or powdered ingredients. In certain embodiments, feed compositions according to the present disclosure comprise a binding agent, an anti-caking agent or both in an amount ranging from about 5 wt % to about 40 wt % of the total amount of the boosted or reference feed composition. Exemplary binding agents include bentonite, dextrin, gelatin, and agar. An exemplary anti-caking agent comprises bentonite.

Any of the aforementioned feed compositions (boosted or reference feed compositions) according to the present disclosure may be formulated as a pellet, a powder, a slurry, flakes, a paste, or any other form suitable for animal feed. Consequently, a feed composition of this disclosure may include various other ingredients used for particular formulations. For example, a viscosity increasing agent may be used in producing a slurry or paste. In certain embodiments, a boosted or reference feed composition further comprises a lubricant, a binding agent, an anti-caking agent or any combination thereof for formulation as a pellet.

### Culture Methods for Producing Bacterial Biomass

A variety of culture methodologies may be used to obtain a methylotrophic bacterium biomass. For example, bacteria may be grown by batch culture or continuous culture methodologies. In certain embodiments, the cultures are grown in a controlled culture unit, such as a fluidized bed reactor, a fermentor, a bioreactor, a hollow fiber membrane bioreactor, a packed bed bioreactor, or the like.

A classical batch culturing method is a closed system where the composition of the media is set at the beginning of the culture and not subject to external alterations during the culture process. Thus, at the beginning of the culturing process, the media is inoculated with the desired organism and growth or metabolic activity is permitted to occur without adding anything to the system. Typically, however, a “batch” culture is batch with respect to the addition of carbon source (e.g., methane, natural gas, unconventional natural gas, methanol, a methylamine, a methylthiol, or a methylhalogen), and attempts are often made at controlling factors such as pH and oxygen concentration. In batch systems, the metabolite and biomass compositions of the system change constantly up to the time the culture is terminated. Within batch cultures, cells moderate through a static lag phase to a high growth logarithmic phase and finally to a stationary phase where growth rate is diminished or halted. If untreated, cells in the stationary phase will eventually die. Cells in logarithmic growth phase are often responsible for the bulk production of end product or intermediate in some systems. Stationary or post-exponential phase production can be obtained in other systems.

The Fed-Batch system is a variation on the standard batch system. Fed-Batch culture processes comprise a typical batch system with the modification that the substrate is added in increments as the culture progresses. Fed-Batch systems are useful when catabolite repression is apt to inhibit the metabolism of the cells and where it is desirable to have limited amounts of substrate in the media. Measurement of the actual substrate concentration in Fed-Batch systems is difficult and is therefore estimated on the basis of the changes of measureable factors, such as pH, dissolved oxygen, and the partial pressure of waste gases such as CO₂. Batch and Fed-Batch culturing methods are common and known in the art (see, e.g., Thomas D. Brock, Biotechnology: A Textbook of Industrial Microbiology, 2^{nd} Ed. (1989) Sinauer Associates, Inc., Sunderland, Mass.; Deshpande, Appl. Biochem. Biotechnol. 36:227, 1992).

Continuous cultures are “open” systems where a defined culture media is added continuously to a bioreactor and an equal amount of conditioned media is removed simultaneously for processing. Continuous cultures generally maintain the cells at a constant high liquid phase density where cells are primarily in logarithmic phase growth. Alternatively, continuous culture may be practiced with immobilized cells where carbon and nutrients are continuously added and valuable products, by-products, and waste products are continuously removed from the cell mass. Cell immobilization may be performed using a wide range of solid supports composed of natural or synthetic materials.

Continuous or semi-continuous culture allows for the modulation of one factor or any number of factors that affect cell growth or end product concentration. For example, one method will maintain a limited nutrient, such as the carbon source or nitrogen level, at a fixed rate and allow all other parameters to modulate. In other systems, a number of factors affecting growth can be altered continuously while the cell concentration, measured by media turbidity, is kept constant. Continuous systems strive to maintain steady state growth conditions and thus the cell loss due to media being drawn off must be balanced against the cell growth rate in the culture. Methods of modulating nutrients and growth factors for continuous culture processes, as well as techniques for maximizing the rate of product formation, are well known in the art, and a variety of methods are detailed by Brock, supra.

Methyl- or methane-containing carbon substrates can be used to produce the biomass. Exemplary carbon substrates include natural gas, unconventional natural gas, syngas, and methane. As used herein, “natural gas” refers to naturally occurring gas mixtures that have formed in porous reservoirs and can be accessed by conventional processes (e.g., drilling) and are primarily made up of methane, but may also have other components such as carbon dioxide, nitrogen or hydrogen sulfide. As used herein, “unconventional natural gas” refers to a naturally occurring gas mixture created in formations with low permeability that must be accessed by unconventional methods, such as hydraulic fracturing, horizontal drilling or directional drilling. Exemplary unconventional natural gas deposits include tight gas sands formed in sandstone or carbonate, coal bed methane formed in coal deposits and adsorbed in coal particles, shale gas formed in fine-grained shale rock and adsorbed in clay particles or held within small pores or microfractures, methane hydrates that are a crystalline combination of natural gas and water formed at low temperature and high pressure in places such as under the oceans and permafrost. As used herein, “methane” refers to the simplest alkane compound with the chemical formula CH₄. Methane is a colorless and odorless gas at room temperature and pressure. Sources of methane include natural sources, such as natural gas fields, “unconventional natural gas” sources (such as shale gas or coal bed methane, wherein content will vary depending on the source), and biological sources where it is synthesized by, for example, methanogenic microorganisms, and industrial or laboratory synthesis. Methane includes pure methane, substantially purified compositions, such as “pipeline quality natural gas” or “dry natural gas”, which is 95-98% percent methane, and unpurified compositions, such as “biogas” and “wet natural gas” (comprising a higher percentage of liquid natural gases (such as ethane and butane) than dry natural gas, the latter being almost completely methane), wherein other hydrocarbons have not yet been removed, and methane comprises from about 50% to about 75% of the biogas composition and at least about 60% to 85% or less of the wet natural gas composition.

### Animals

Methods and boosted feed compositions according to the present disclosure are useful in improving the accumulation of PFA in an animal. More specifically, the presently disclosed methods can improve PFA accumulation in, for example, chordates, mollusks, arthropods, annelids, cnidarians, and poriferans. In certain embodiments, the animal is a farm animal, farmed animal, or a domesticated animal (e.g., a dog or a cat). In certain embodiments, a farm or farmed animal accumulates the one or more PFAs in flesh. In certain embodiments, the farmed animal accumulates the one or more PFAs in an edible portion.

Exemplary farmed fish (i.e., fin fish) that can be fed the boosted compositions of this disclosure include a barramundi, a bluegil, a sunfish, a sable fish, a carp, a catfish, an eel, a Golden shiner, a hybrid stripped bass, a largemouth bass, a kampachi, a salmon, a sturgeon, a tilapia, a brook trout, a brown trout, a rainbow trout, a walleye, a yellow perch, and a yellowtail amberjack. Exemplary farmed shellfish that can be fed the boosted compositions of this disclosure include shrimp, crayfish, scallops, clams, oysters and mussels. Exemplary domesticated animals that can be fed the boosted compositions of this disclosure include dogs and cats.

### Methods

Feed compositions according to the present disclosure may be fed to animals according to schedules and in amounts appropriate to the animal, which details are known to those having ordinary skill in the art. In various embodiments of the methods of this disclosure, a boosted feed composition is fed to an animal once per day, twice per day, three times per day, four times per day, or more, or is provided continuously. In certain embodiments, a methylotrophic bacterial biomass and reference feed composition (or the modified reference feed composition) are administered separately to the animal. In other embodiments, a methylotrophic bacterial biomass and reference feed composition (or modified reference feed composition) are formulated for administration together (e.g., as a single feed composition product, such as a pellet).

### EXAMPLES

### Example 1

### Digestibility of Feed Compositions Comprising Methylotrophic Bacterial Biomass

As ingredients in aquaculture feed, fish meal and fish oil supply an almost perfect balance of essential amino acids and fatty acids for fish to be healthy and grow. For example, fish oil is a major natural source of healthy polyunsaturated fatty acids, like the omega-3 fatty acids eicosapentaenoic acid (EPA) and docosahexaenoic acid (DHA), which are not made by the fish. Fish meal also contains residual, but significant amounts of these PFAs. Marine phytoplankton (microscopic marine algae and microbes) do synthesize omega-3 fatty acids, which is the source of these fatty acids that become concentrated in fish. But, the rising demand from an ever growing aquaculture industry has put pressure on traditional sources of fish meal and driven prices to record highs (Fish 2.0 Market Report, 2015). Various alternatives to fish meal and/or fish oil are being developed, but these alternatives, which include plant-based sources, animal by-products and vegetable or nut meals, all have lower amounts of PFAs, lack the requisite marine-based protein profile for growth and have varying constraints with respect to cost, supply, and sustainability (Id.).

To examine the effect of reducing the amount of PFAs in fish feed, a methylotrophic bacterial biomass was used to replace either fish meal and/or one or more other ingredients found in the reference (standard) fish meal for yellowtail amberjack. Three different diet treatments (i.e., boosted feed compositions), containing varying amounts of methylotrophic bacterial biomass (referred to a “Bacterial Meal” or “BM”) and a reduced amount of fish meal, were prepared as shown in Table 1.

TABLE 1
Fish Diet Treatments Replacing Fishmeal with Bacterial Biomass

| Ingredient | Diet Treatment | | | |
|---|---|---|---|---|
| Bacterial meal | 0 | 58.85 | 146.84 | 294 |
| (% BM)* | (0% BM) | (10% BM) | (25% BM) | (50% BM) |
| Fish Meal | 514.93 | 462.5 | 385.6 | 257 |
| Dextrin | 254.54 | 244.92 | 230.53 | 206.47 |
| Fish Oil | 90.53 | 90.33 | 90.03 | 89.53 |
| Soy Protein Concentrate | 50 | 50 | 50 | 50 |
| Alginate | 30 | 30 | 30 | 30 |
| Schizochytrium Meal | 20 | 20 | 20 | 20 |
| Vitamin Premix | 20 | 20 | 20 | 20 |
| Taurine | 10 | 11 | 12.5 | 15 |
| Mineral Premix | 10 | 10 | 10 | 10 |
| Lysine | 0 | 1.4 | 3.5 | 7 |
| Yttrium oxide | 1 | 1 | 1 | 1 |

*% BM refers to the percentage of fish meal replaced with bacterial meal.

The boosted feed compositions of Table 1 are shown to contain BM replacing fish meal at the following levels: 10% BM (meaning actual range of 8% to 14%), 25% BM (meaning actual range of 21% to 29%), 50% BM (meaning actual range of 45% to 58%). The percentage of BM in the total feed composition comprises 3% (ranging from 1% to 5%), 15% (ranging from 10% to 20%), and 30% (ranging from 25% to 35%). The diet treatment labeled 0% BM of Table 1 is the reference feed (control) for this experiment (i.e. , fish meal amount is not reduced or replaced). Percentages indicate the percent dry weight of the ingredient present in the feed composition. Each of the diet treatments (control reference feed and three different test boosted feed compositions) were fed to yellowtail amberjack (6 fish per treatment) for 80 days. Throughout the course of the experiment, fish swam on “water treadmills,” allowing calculation and tracking of the calories burned by the animals. Detritus was collected from the fish and analyzed for protein, fat and ash content as a measure of digestability.

The Apparent Digestibility (AD) of four major components of the diet treatments (protein, fat, ash, and calories) was calculated based on the fish input (diet treatment) and output (calories and detritus content), which is calculated by subtracting the total outflow of a given component (i.e., in detritus) from the quantity ingested by the animal (see Table 2). For example, AD may be calculated using the following formula:

AD (%) of protein=[[protein intake−protein present in detritus)/protein intake]×100]

AD reflects the net disappearance of a given dietary ingredient or component prior to outflow from the animal.

TABLE 2
Apparent Digestibility of Diet Treatment Components in Yellowtail

Apparent Digestibility (% Dry Weight)

| Ingredient | 0% BM | 10% BM | 25% BM | 50% BM |
|---|---|---|---|---|
| Protein | 86.97 | 85.85 | 87.72 | 91.81 |
| Fat | 90.78 | 92.31 | 93.21 | 96.10 |
| Ash | 98.91 | 99.04 | 98.87 | 99.50 |
| Calories | 91.34 | 92.15 | 91.86 | 94.24 |

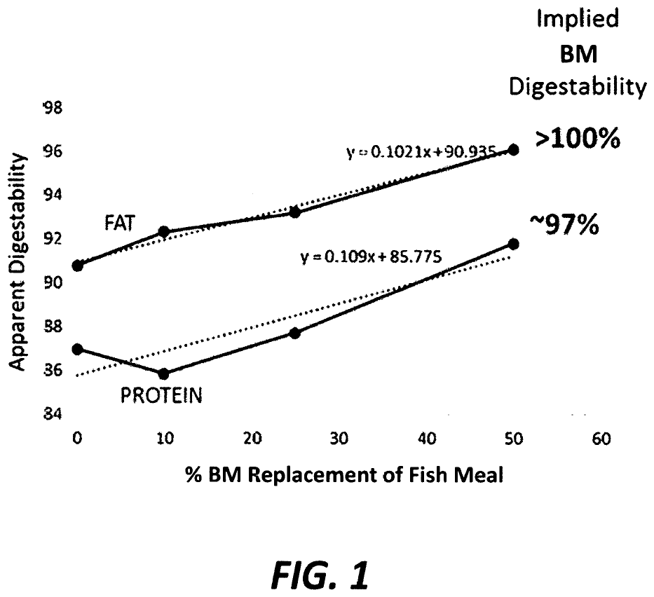

As shown in Table 2, the AD of ash, an indigestible byproduct of the cooking process used to make the feed compositions, did not significantly differ across the diet treatments. The ability to burn calories showed a slight increase in animals fed test boosted feed compositions. Surprisingly, however, the data show that inclusion of bacterial biomass in the diet of the tested fish resulted in improved absorption of protein and fat from the diet. In fact, these data indicate that inclusion of bacterial biomass in the fish diet improves the absorption and accumulation of other fatty acids in the diet, such as omega-3 fatty acids found in fish oil (the primary oil component of the feed), even though the level of such omega-3 oils were significantly decreased in the boosted feed composition (due to the removal of fish meal, which contains residual omega-3 oils) (see FIG. 1).

These data show that partially replacing fish meal, a standard source of protein and fats in aquaculture diets, with bacterial biomass can improve uptake of these nutrients in fish (see FIG. 1). A surprising result is the increase in omega-3 fatty acid accumulation in the fish despite the reduced amount of PFAs in the feed (see Example 2).

### Example 2

### Polyunsaturated Fatty Acid Accumulation in Yelowtail Amberjack Fish Fed a Feed Containing Bacterial Biomass and Reduced Fish Meal

Fish are an important source of high-value polyunsaturated fatty acids (PFAs) for human consumers. Data from the experiment described in Example 1 indicate that fish accumulate dietary fats more effectively when a bacterial biomass is included in the feed, even though the amount of PFAs present in the feed are reduced. This is particularly surprising given that the bacterial biomass was used to replace the fish meal component, which contains residual amounts of fish oil yet provides a significant amount to the dietary load of PFAs.

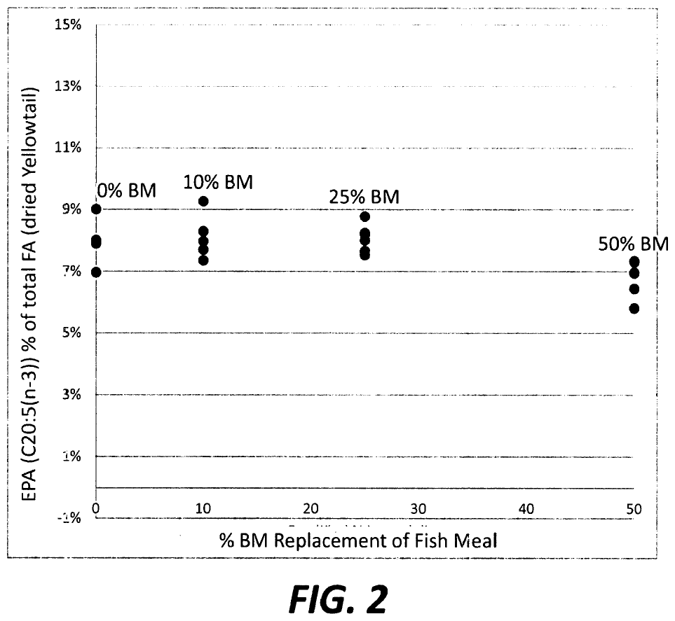

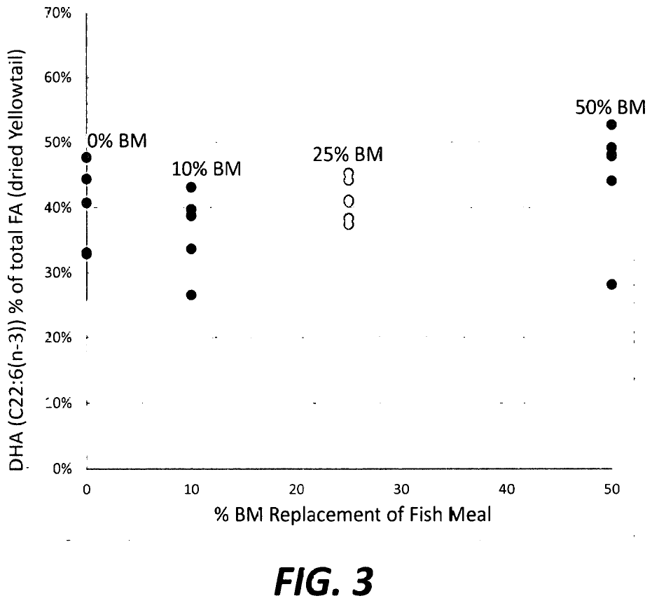

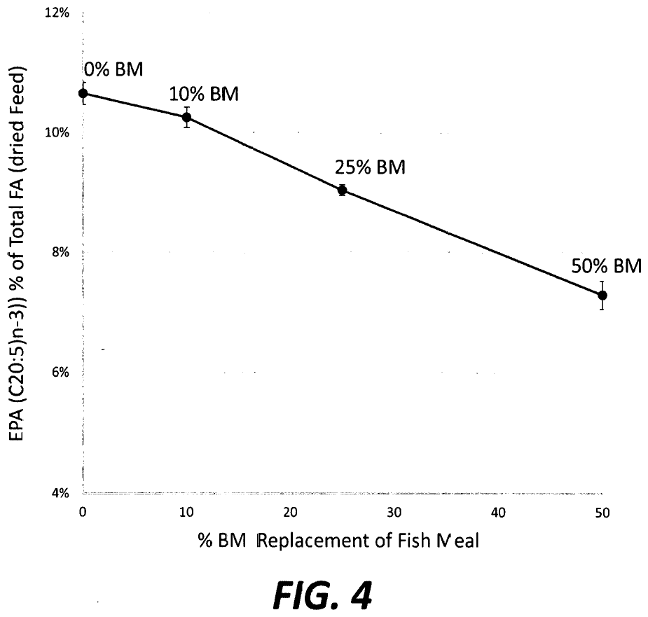

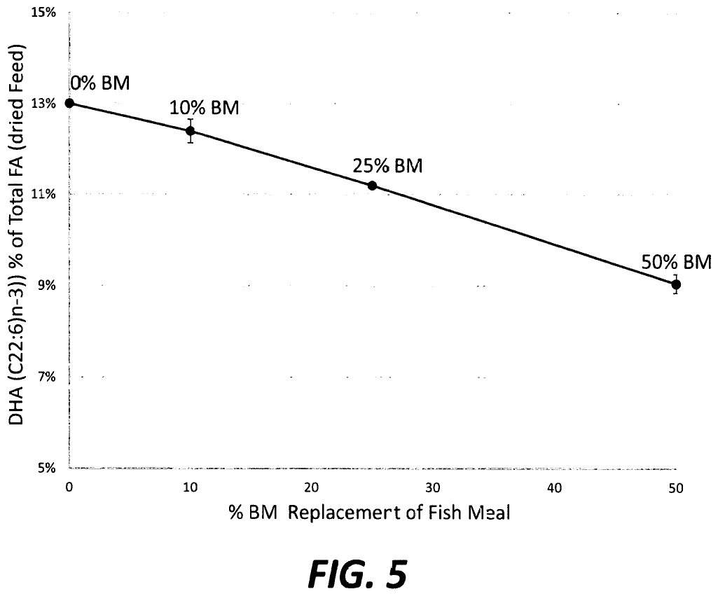

To examine which fatty acids were being absorbed and accumulated in yellowtail amberjack fish fed the test boosted feed compositions having fish meal replaced with methylotrophic bacteria biomass, dried samples of fish fillets from each feed group in Example 1 (0% (control), 10%, 25%, and 50% wt/wt BM) were analyzed for eicosapentaenoic acid (EPA) and docosahexanoic acid (DHA) content. Despite a substantial decrease in the amounts of EPA and DHA found in the test boosted feed compositions (see FIGS. 4 and 5, respectively), the level of EPA and DHA that accumulated in the fish was either maintained or had a pronounced increase (see FIGS. 2 and 3).

These data show that replacing PFA-containing ingredients (e.g., fishmeal) with bacterial biomass in a standard or reference feed can surprisingly lead to a maintained or increased absorption and accumulation of PFAs, such as EPA and DHA, by the animal (in this case, yellowtail amberjack fish).

### Example 3

### Polyunsaturated Fatty Acid Accumulation in Northern Trout (Oncorhynchus Mykiss) Fed a Bacterial Biomass Containing Feed with Reduced Fish Meal

To examine whether the beneficial effects of partial replacement of fish meal by bacterial biomass (i.e., improved uptake of proteins and fats) could be extended to other fish species, bacterial biomass was used to partially replace either fish meal and/or one or more other ingredients in the reference (standard) fish meal for northern trout (Oncorhynchus mykiss). Three different diet treatments (i.e., boosted feed compositions), containing varying amounts of bacterial biomass and a reduced amount of fish meal, were prepared as shown in Table 3.

TABLE 3
Northern Trout Feed Replacing Fish Meal with Bacterial Biomass

| Ingredient | Diet Treatment | | | |
|---|---|---|---|---|
| Bacterial meal | 0 | 100 | 200 | 350 |
| (% BM) | (0% BM) | (10% BM) | (20% BM) | (35% BM) |
| Fish Meal | 450 | 350 | 250 | 100 |
| Wheat gluten | 133.7 | 134.4 | 135.1 | 136.2 |
| Wheat meal | 218.4 | 209.6 | 200.8 | 187.8 |
| Fish oil | 172.8 | 168.8 | 164.8 | 158.8 |
| Vitamin and mineral | 10 | 10 | 10 | 10 |
| premix | | | | |
| Methionine | 5 | 5 | 5 | 5 |
| Vitamin C | 0.1 | 0.1 | 0.1 | 0.1 |
| TiO₂ | 10 | 10 | 10 | 10 |
| CaCO₃ | 0 | 8.5 | 17 | 29.6 |
| Monocalcium | 0 | 3.6 | 7.2 | 12.5 |
| phosphate | | | | |

The boosted feed compositions of Table 3 are shown to contain BM at the following levels: 10% BM, 20% BM, 35% BM of the total feed composition. The diet treatment labeled 0% BM of Table 3 is the reference feed (control) for this experiment. Percentages indicate the percent dry weight of the ingredient present in the feed composition.

Each of the diet treatments (4 feeds total—one control reference feed and three different test boosted feed compositions) were fed to northern trout (360 total fish were divided into 12 tanks of 30 fish per tank and acclimatized for 1 week, and each feed was given to 3 tanks that is, 90 fish per treatment) for 49 days (7 weeks). Detritus was collected from the fish and analyzed for TiO₂ marker, protein and fat content as a measure of digestability.

The Apparent Digestibility Coefficient (ADC) of the protein and fat components of the diet treatments was calculated based on the fish input (diet treatment) and output (detritus content) (see Table 4), while taking into consideration the amount of the TiO₂ marker in diet and detritus (see, e.g., Vandenberg and De La Notie, Aquac. Nutr. 7:237, 2001). For example, ADC of protein may be calculated using the following formula:

$$ADC of protein = 100 - ( 100 * ( \frac{Marker in Diet * Protein in Detritus}{Marker in Detritus * Protein in Diet} ) )$$

TABLE 4
Apparent Digestibility of Diet Treatment Components in Trout

| | Apparent Digestibility Coefficient (%) | | | |
|---|---|---|---|---|
| Ingredient | 0% BM | 10% BM | 20% BM | 35% BM |
| Protein | 93.26 ± 0.75 | 90.23 ± 1.72 | 86.83 ± 2.41 | 83.42 ± 1.44 |
| Fat | 89.94 ± 0.11 | 88.95 ± 1.88 | 85.34 ± 3.01 | 84.22 ± 1.96 |

Here, both protein and fat digestibility were essentially identical with a slight trend downward with increasing inclusion of bacterial meal in the diet. However, there was no significant difference (p>0 .05) in apparent digestibility of fat between the four diets.

Nutrient Retention (i.e., percentage of a nutrient in the ingested diet that was retained by the fish) of the protein and fat components of the diet treatments was calculated based on the diet treatment and characteristics of the fish (see Table 5). For example, nutrient retention of protein may be calculated using the following formula:

$$Nutrient Retention of protein = ( 100 * ( \frac{Protein Gain During Growth}{Protein Consumed} ) )$$

TABLE 5
Nutrient Retention of Diet Componentsin Trout

| | Nutrient Retention (%) | | | |
|---|---|---|---|---|
| Ingredient | 0% BM | 10% BM | 20% BM | 35% BM |
| Protein | 34.48 ± 1.04 | 38.53 ± 0.75 | 38.26 ± 0.36 | 38.27 ± 0.7 |
| Fat | 67.36 ± 1.98 | 78.11 ± 1.49 | 79.28 ± 0.63 | 88.89 ± 1.52 |

There was no significant difference (p>0. 05) in protein retention between the four diets. However, there was a clear trend of increased protein retention in trout that were fed diets supplemented with bacterial meal (10% BM, 20% BM, 35% BM), as compared to the reference feed (0% BM).

Lipid retention was significantly lower with the reference feed treatment, as compared to the bacterial meal-containing diet treatments. In fact, there was a strong trend showing higher lipid retention with increasing percentage of bacterial meal inclusion in the test diet. These results indicate that inclusion of bacterial meal in diet treatments contributed to higher fat retention by the fish. This, in turn, suggests that fats in diets supplemented with the bacterial meal are converted to bodily lipids more efficiently than fats in diets not supplemented with the bacterial meal.

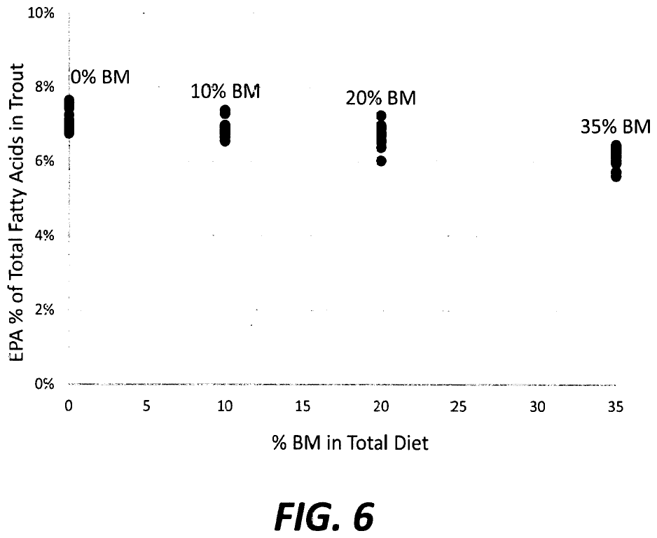

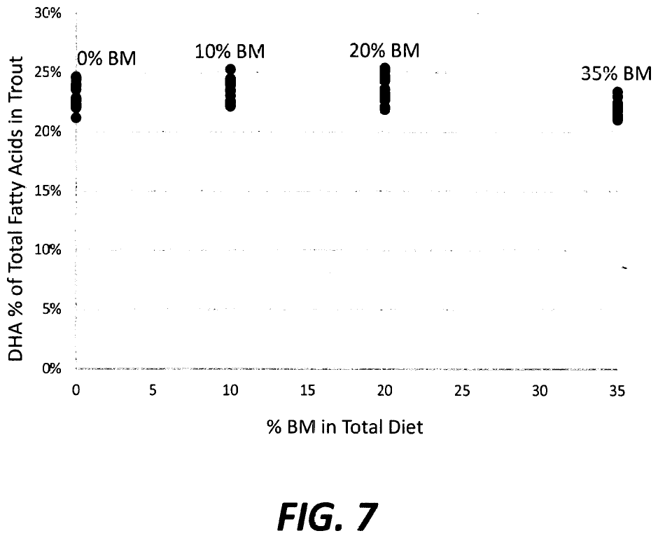

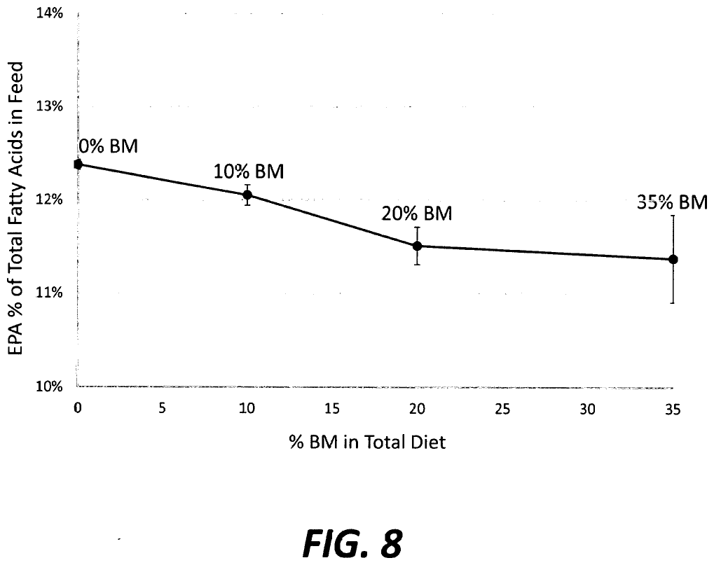

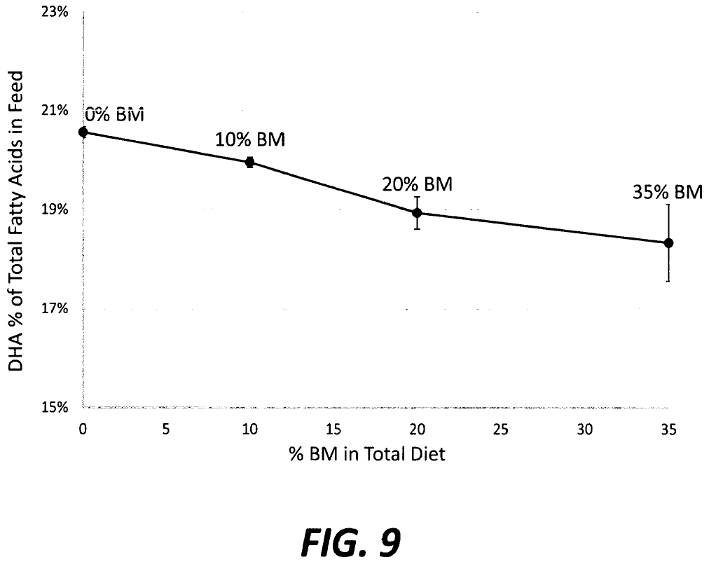

To examine which fatty acids were being absorbed and accumulated in trout/fish, dried samples of fish from each feed group in this Example (0% (control), 10%, 20%, and 35% wt/wt BM) were analyzed for eicosapentaenoic acid (EPA) and docosahexanoic acid (DHA) content. Despite a substantial decrease in the amounts of EPA and DHA found in the test boosted feed compositions (see FIGS. 8 and 9, respectively), the level of EPA and DHA that accumulated in the fish/trout was either maintained or had a mild decrease at the highest inclusion level (35% BM) (see FIGS. 6 and 7).

These data show that replacing PFA-containing ingredients (e.g., fish meal) with bacterial biomass in a standard or reference feed can surprisingly lead to a maintained or increased absorption and accumulation of PFAs, such as EPA and DHA, in multiple fish species. Moreover, these data also indicate that lower-cost feeds having bacterial biomass in place of high-cost ingredients (such as fish oil or fish meal) can be fed to animals (e.g., fish, shrimp, etc.) who will accumulate as much or more PFAs as compared to an animal fed a higher-cost reference feed containing higher amounts of PFA (i.e., containing more expensive fish oil or fish meal).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional Patent Application No. 62/546,311, filed Aug. 16, 2017, and U.S. Provisional Patent Application No. 62/589,408, filed Nov. 21, 2017, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for improving accumulation of a polyunsaturated fatty acid in an animal, comprising:
(1) feeding to an animal in an amount and for a time sufficient for the animal to consume and assimilate the feed:
(a) a modified reference feed composition comprising a reduced amount of one or more polyunsaturated fatty acids as compared to the unmodified reference feed composition; and
(b) a methylotrophic bacterial biomass in an amount ranging from about 5% wt/wt to about 55% wt/wt of the total amount of the modified reference feed composition and the methylotrophic bacterial biomass;
(2) testing a tissue sample from the animal for accumulation of one or more polyunsaturated fatty acids after step (1);
wherein the animal that has consumed the modified reference feed composition and the methylotrophic bacterial biomass accumulates about the same or an increased amount of the one or more polyunsaturated fatty acids as compared to a control animal that is fed and has consumed the unmodified reference feed composition.

2-5. (canceled)

6. A method for improving accumulation of a polyunsaturated fatty acid in an animal, comprising:
(1) feeding to an animal in an amount and for a time sufficient for the animal to consume and assimilate the feed:
(a) a modified reference feed composition comprising the same or about the same amount of one or more polyunsaturated fatty acids as compared to the unmodified reference feed composition; and
(b) a methylotrophic bacterial biomass in an amount ranging from about 5% wt/wt to about 55% wt/wt of the total amount of the modified reference feed composition and the methylotrophic bacterial biomass;
(2) testing a tissue sample from the animal for accumulation of one or more polyunsaturated fatty acids after step (1);
wherein the animal that has consumed the modified reference feed composition and the methylotrophic bacterial biomass accumulates an increased amount of the polyunsaturated fatty acid as compared to a control animal that is fed and has consumed the unmodified reference feed composition.

7. The method of claim 6, wherein the methylotrophic bacterial biomass and the modified reference feed composition are fed to the animal separately.

8. The method of claim 6, wherein the the methylotrophic bacterial biomass and the modified reference feed composition are formulated together as a mixture, wherein the mixture is fed to the animal.

9. The method of claim 6, wherein the methylotrophic bacterial biomass comprises a methanotroph.

10. The method according to claim 9, wherein the methanotroph is a Methylococcus capsulatus Bath, Methylosinus trichosporium OB3b, Methylomonas sp. 16a, Methylomonas methanica, Methylomonas albus, Methylomicrobium alcaliphilum, Methylobacter capsulatus, Methylomonas sp. AJ-3670, Methylomicrobium buryatense 5G, Methylosinus sporium, Methylocystis parvus, Methylocapsa palsarum, Methylobacterium or ganophilum, Methylocella silvestris, Methylocella palustris, Methylocella tundrae, Methylocystis daltona SB2, Methylocystis bryophila, Methylocapsa aurea KYG, Methylacidiphilum fumariolicum, Methyloacida kamchatkensis, Methylacidiphilum infernorum, or a high-growth variant thereof.

11. The method of claim 6, wherein the methylotrophic bacterial biomass comprises a methylotroph.

12. The method of claim 11, wherein the methylotroph is Methylobacterium extorquens, Methylobacterium radiotolerans, Methylobacterium populi, Methylobacterium chloromethanicum, Methylobacterium nodulans, or a high growth variant thereof.

13. The method of claim 6, wherein the methylotrophic bacterial biomass comprises a combination of a methylotroph biomass and a methanotroph biomass, or a combination of a methanotroph biomass and a heterologous organism.

14. The method of claim 6, wherein the one or more polyunsaturated fatty acids in the methylotrophic bacterial biomass and the modified reference feed composition comprises one or more omega-3 fatty acids.

15. The method of claim 14, wherein:
(a) the one or more omega-3 fatty acids comprises docosahexanoic acid (DHA);
(b) the one or more omega-3 fatty acids comprises eicosapentaenoic acid (EPA); or
(c) the one or more omega-3 fatty acids comprises docosahexanoic acid (DHA) and eicosapentaenoic acid (EPA).

16-17. (canceled)

18. The method of claim 6, wherein the animal is a farm animal, a farmed animal, or a domesticated animal.

19. The method of claim 18, wherein:
(a) the farm animal is a cow, pig, sheep, chicken, turkey, or horse;
(b) the domesticated animal is a dog or a cat;
(c) the farmed animal is a chordate, a mollusk, an arthropod, an annelid, a enidarian, or a porifera; or
(d) the farmed animal is a fish, a crayfish, or a shrimp.

20-22. (canceled)

23. The method of claim 6, wherein the animal is a fish or a shrimp.

24. The method of claim 23, wherein:
(a) the fish is a salmonid, a mackerel, or a herring; or
(b) the fish is a barramundi, a bluegil, a sunfish, a sable fish, a carp, a catfish, an eel, a Golden shiner, a hybrid stripped bass, a largemouth bass, a kampachi, a salmon, a sturgeon, a tilapia, a brook trout, a brown trout, a rainbow trout, a walleye, a yellow perch, or a yellowtail amberjack.

25-26. (canceled)

27. The method of claim 6, wherein the methylotrophic bacterial biomass and the modified reference feed composition are fed to the animal once per day, twice per day, three times per day, or four times per day, or is provided continuously.

28. The method of claim 6, wherein the animal accumulates the one or more polyunsaturated fatty acids in the animal's flesh or in an edible portion of the animal.

29. (canceled)

30. The method of claim 6, wherein the modified reference feed composition comprises an altered amount of a polyunsaturated fatty acid-containing component, a protein, a plant component, an organic acid, an oil, a vitamin, a mineral, a viscosity increasing agent, a binding agent, an anti-caking agent, or any combination thereof, as compared to the unmodified reference feed composition.

31. The method of claim 6, wherein the methylotrophic bacterial biomass and the modified reference feed composition comprise a polyunsaturated fatty acid-containing component in an amount ranging from about 1 wt % to 70 wt % of the total amount of the methylotrophic bacterial biomass and the modified reference feed composition; and/or
wherein the polyunsaturated fatty acid-containing component comprises fish oil, fish meal, squid oil, squid meal, squid liver powder, algal oil, shrimp head meal, krill oil, krill meal, or any combination thereof.

32. (canceled)

33. The method of claim 6, wherein the methylotrophic bacterial biomass and the modified reference feed composition comprise a plant component in an amount ranging from about 1 wt % to about 40 wt % of the total amount of the methylotrophic bacterial biomass and the modified reference feed composition; and/or
wherein the plant component comprises soy, sunflower, rapeseed, wheat, fava beans, pea, maize, horse beans, dried distillers grains with solubles (DDGS), or any combination thereof.

34. (canceled)

35. The method of claim 6, wherein the methylotrophic bacterial biomass and the modified reference feed composition comprise a protein in an amount ranging from about 1 wt % to about 70 wt % of the total amount of the methylotrophic bacterial biomass and the modified reference feed composition; and/or
wherein the protein comprises one of more of a plant protein, a fish protein, an algal protein, and a bacterial protein.

36-39. (canceled)

40. The method of claim 6, wherein the methylotrophic bacterial biomass and the modified reference feed composition comprise one or more of a vitamin in an amount ranging from about 0.01wt % to about 5 wt % of the total amount of the methylotrophic bacterial biomass and the modified reference feed composition; and/or
wherein the one or more vitamin comprises a vitamin premix.

41. (canceled)

42. The method of claim 6, wherein the methylotrophic bacterial biomass and the modified reference feed composition comprise one or more of a mineral in an amount ranging from about 0.01 wt % to about 5 wt % of the total amount of the methylotrophic bacterial biomass and the modified reference feed composition; and/or
wherein the one or more mineral comprises a mineral premix.

43. (canceled)

44. The method of claim 6, wherein the methylotrophic bacterial biomass and the modified reference feed composition comprise an organic acid in an amount ranging from about 0.05 wt % to about 2.5 wt % of the total amount of the methylotrophic bacterial biomass and the modified reference feed composition;
wherein the organic acid comprises taurine.

45. (canceled)

46. The method of claim 6, wherein the methylotrophic bacterial biomass and the modified reference feed composition comprise algal meal in an amount ranging from about 0.5 wt % to about 5 wt % of the total amount of the methylotrophic bacterial biomass and the modified reference feed composition; and/or
wherein the algal meal comprises a Schizochytrium metal.

47. (canceled)

48. The method of claim 6, wherein the methylotrophic bacterial biomass and the modified reference feed composition comprise a viscosity-increasing agent in an amount ranging from about 1 wt % to about 5 wt % of the total amount of the methylotrophic bacterial biomass and the modified reference feed composition; and/or
wherein the viscosity-increasing agent comprises alginate or bentonite.

49. (canceled)

50. The method of claim 6, wherein the methylotrophic bacterial biomass and the modified reference feed composition comprise a binding agent in an amount ranging from about 5 wt % to about 30 wt % of the total amount of the methylotrophic bacterial biomass and the modified reference feed composition; and/or
wherein the binding agent comprises alginate, dextrin, or both.

51. (canceled)

52. The method of claim 6, wherein the methylotrophic bacterial biomass and the modified reference feed composition further comprise a supplement, and/or
wherein the supplement comprises one or more of an antioxidant, a probiotic, a colorant, an odorant, an attractant, a palatant, and an essential amino acid.

53. (canceled)

54. The method of 52, wherein the methylotrophic bacterial biomass and the modified reference feed composition comprise the essential amino acid supplement in an amount ranging from about 0.001 wt % to about 1.5 wt % of the total amount of the methylotrophic bacterial biomass and the modified reference feed composition; and/or
wherein the essential amino acid supplement comprises one or more of lysine, methionine, and tryptophan.

55. (canceled)

56. The method of claim 6, wherein the methylotrophic bacterial biomass and the modified reference feed composition comprise a plant oil in an amount ranging from the 5 wt % to about 35 wt % of the total amount of the methylotrophic bacterial biomass and the modified reference feed composition;
wherein the plant oil comprises rapeseed oil, walnut oil, clary sage seed oil, algal oil, flaxseed oil, Plukenetia oil, Echium oil, hemp oil, or any combination thereof.

57. (canceled)

58. The method of claim 6, wherein;
(a) the methylotrophic bacterial biomass and the modified reference feed composition comprise the methylotrophic bacterial biomass in an amount ranging from about 5 wt % to about 55 wt % of the total amount of of the methylotrophic bacterial biomass and the modified reference feed composition, and a fish meal in an amount ranging from about 10 wt % to about 70 wt % of the total amount of the methylotrophic bacterial biomass and the modified reference feed composition;
(b) the methylotrophic bacterial biomass and the modified reference feed composition comprise the methylotrophic bacterial biomass in an amount ranging from about 10 wt % to about 50 wt % of the total amount of the methylotrophic bacterial biomass and the modified reference feed composition, and a fish meal in an amount ranging from about 20 wt % to about 50 wt % of the total amount of the methylotrophic bacterial biomass and the modified reference feed composition; or
(c) the methylotrophic bacterial biomass and the modified reference feed composition comprise the methylotrophic bacterial biomass in an amount ranging from about 25 wt % to about 50 wt % of the total amount of the methylotrophic bacterial biomass and the modified reference feed composition, and a fish meal in an amount ranging from about 20 wt % to about 40 wt % of the total amount of the methylotrophic bacterial biomass and the modified reference feed composition.

59-60. (canceled)

61. The method of claim 6, wherein the methylotrophic bacterial biomass and the modified reference feed composition are formulated as a pellet.
